(19) United States
(12) Patent Application Publication
(10) Pub. No.: US 2007/0033094 A1
(43) Pub. Date: Feb. 8, 2007

(54) Methods, systems, and related computer program products for interactive advertising using product placement

(76) Inventor: William Hartselle, Norcross, GA (US)

Correspondence Address: MYERS BIGEL SIBLEY & SAJOVEC, P.A., P.O. BOX 37428, RALEIGH, NC, 27627, US

(21) Appl. No.: 11/199,318

(22) Filed: Aug. 8, 2005

(51) Int. Cl. G06Q 99/00; G07G 1/00; G06F 17/30

(52) U.S. Cl. 705/10; 705/1

(57) ABSTRACT

Methods of obtaining interactive feedback from a third party consumer of audiovisual content include receiving a response from the third party consumer, the response including at least a marker identification message identifying one or more embedded consumer recognition markers in the audiovisual production. A marker correlation metric is generated based on the marker identification message and compared to a threshold. A response is provided to the third party consumer in response to the marker correlation metric exceeding the threshold. Systems and related computer program products for obtaining interactive feedback from a third party consumer of audiovisual content are also disclosed.

### FIELD OF THE INVENTION

The invention relates to systems and methods for interactive advertising. In particular, the invention relates to systems and methods for interactive advertising using product placements.

### BACKGROUND

The implementation of interactive television services has permitted advertisers to explore new methods for providing targeted advertisements to consumers. For example, consumer viewing habits and choices may be monitored to establish viewing preferences and purchasing habits. Such information may be used to tailor advertising of particular products and/or services to individual consumers. Such targeted advertising may be useful for certain types of advertising campaigns, for example, advertising campaigns for specialty use or special purpose products.

For certain types of products however, targeted advertising may be less important than building name recognition and/or product recognition among the general public. In order to build name recognition and/or product awareness, advertisers have frequently sought to link or otherwise associate their products with particular lifestyles, images, personalities, etc., by placing their products in movies, television shows, and more recently, video games. Advertisers hope that by placing their products in such media forms, the products will become associated with, for example, a particular actor, a genre, and/or lifestyle associated with the movie, television show or game.

In conventional product placement advertising, it may be difficult to coordinate product placement advertising with other advertising mechanisms in an overall advertising campaign. This may be due, for example, to the sometimes lengthy delays associated with production of a movie or television show and the subsequent release and/or broadcast of the program. The schedule and timing of the release and/or broadcast of the program may be subject to numerous influences and, in most cases, may be out of the control of the advertiser completely. Thus, it may be difficult for advertisers to plan and coordinate advertising campaigns incorporating product placements.

Likewise, it may be difficult for producers of audiovisual content to incorporate product placements into their programs, since in most cases arrangements for product placements may have to be in place at least before production of the program has completed.

### SUMMARY

Some embodiments of the invention provide methods of obtaining interactive feedback from a third party consumer of audiovisual content. Methods according to some embodiments of the invention include receiving a response from the third party consumer, the response identifying one or more embedded consumer recognition markers in an audiovisual production provided to the third party consumer. A marker correlation metric is generated based on the marker identification message and compared to a threshold.

A response may be provided to the third party consumer in response to the marker correlation metric exceeding the threshold. Some embodiments of the invention further include sending a response request message to the third party consumer.

Further embodiments of the invention include providing the consumer marker recognition message to a response server having a database and retrieving a record from the database corresponding to the consumer recognition marker.

The response server may further include a consumer identification database, and the response may identify the third party consumer. Accordingly, some embodiments of the invention further include retrieving a consumer identification record associated with the consumer identification message responsive to a marker correlation metric exceeding the threshold.

In some embodiments of the invention, the consumer identification message may include a consumer identification code, and methods may further include selecting a consumer identification record for retrieval based on the consumer identification code.

In some embodiments of the invention, providing the audiovisual program to a third party consumer may include providing the audiovisual program to an audiovisual display device. The audiovisual display device may include a television set, a set-top box, a videogame controller, a handheld computer, a personal digital assistant (PDA), or a cellular telephone.

Methods according to some embodiments of the invention further include embedding at least one consumer recognition marker in an audiovisual content, for example, by placing a product in an audiovisual production. Embedding at least one consumer recognition marker may performed after production of the audiovisual program. In particular, a consumer recognition marker may be digitally inserted into an audiovisual program.

Some methods according to the invention may further include providing a reward to the third party consumer in response to the marker correlation metric exceeding the threshold. The reward may include, for example, entry into a sweepstakes, a song download, a game download, and/or access to a protected website. In embodiments wherein the reward includes entry into a sweepstakes, the number of sweepstakes entries awarded to the third party consumer may be based on the marker correlation metric.

Methods according to some embodiments of the invention include transmitting the audiovisual program to the third party consumer over a communication network. The communication network may include, for example, a cable television distribution network, a satellite network, a cellular communication network, a telephone network, and/or the Internet. Moreover, receiving a response from the third party consumer may include receiving a response over the communication network. Alternatively, receiving a response from the third party consumer may include receiving a response using an interactive voice response system.

A system for obtaining interactive feedback from a third party consumer of audiovisual content according to some embodiments of the invention includes a response server configured to receive a response from the third party consumer including at least a marker identification message identifying one or more embedded consumer recognition markers in the audiovisual production and a consumer identification message identifying the consumer. The response server is further configured to generate a marker correlation metric based on the marker identification message.

In some embodiments of the invention, the response server is further configured to compare the marker correlation metric to a threshold, and to provide a response to the third party consumer in response to the marker correlation metric exceeding the threshold.

Further embodiments of the invention include a media server configured to embed at least one consumer recognition marker in an audiovisual program. The media server may be further configured to transmit a response request message to the third party consumer.

The response server may include a database and may be configured to retrieve a record from the database corresponding to the consumer recognition marker. The response server may further include a consumer identification database and may be further configured to retrieve a consumer identification record associated with the consumer identification message in response to the marker correlation metric exceeding a threshold.

In some embodiments of the invention, the response server may include a marker identification database. The response server may be configured to retrieve stored marker identification information from the marker identification database regarding consumer recognition markers embedded in the audiovisual program and generate a marker correlation metric based on a comparison of the stored marker identification information with the marker identification message.

Some embodiments of the invention provide computer program products for obtaining interactive feedback from a third party consumer of audiovisual content including a computer readable medium having computer readable program code embodied therein. The computer readable program product may include computer readable program code configured to (a) receive a response from the third party consumer, the response identifying one or more embedded consumer recognition markers in an audiovisual program provided to the third party consumer, and (b) generate a marker correlation metric based on the response.

The computer readable program code may be further configured to compare the marker correlation metric to a threshold, and to provide a response to the third party consumer in response to the marker correlation metric exceeding the threshold.

The computer readable program code may be further configured to transmit a response request message to the third party consumer.

Likewise, the computer readable program code may be configured to retrieve a record from a database corresponding to the consumer recognition marker.

In some embodiments, the computer readable program code may be configured to retrieve a consumer identification record associated with the consumer identification message from a consumer identification database in response to the marker correlation metric exceeding a threshold.

The computer readable program code may be configured to retrieve stored marker identification information from a marker identification database regarding consumer recognition markers embedded in the audiovisual program and generate a marker correlation metric based on a comparison of the stored marker identification information with the marker identification message.

Other systems, methods, and/or computer program products according to embodiments will be or become apparent to one with skill in the art upon review of the following drawings and detailed description. It is intended that all such additional systems, methods, and/or computer program products be included within this description, be within the scope of the present invention, and be protected by the accompanying claims.

### BRIEF DESCRIPTION OF THE DRAWINGS

The accompanying drawings, which are included to provide a further understanding of the invention and are incorporated in and constitute a part of this application, illustrate certain embodiment(s) of the invention. In the drawings:

FIGS. 1-6 are schematic diagrams of systems according to some embodiments of the invention; and

FIGS. 7-9 are block diagrams of methods according to some embodiments of the invention.

### DETAILED DESCRIPTION

Embodiments of the present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present invention. As used herein, the term “and/or” includes any and all combinations of one or more of the associated listed items.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” “comprising,” “includes” and/or “including” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this invention belongs. It will be further understood that terms used herein should be interpreted as having a meaning that is consistent with their meaning in the context of this specification and the relevant art and will not be interpreted in an idealized or overly formal sense unless expressly so defined herein.

The present invention is described below with reference to block diagrams and/or flowchart illustrations of methods, apparatus (systems) and/or computer program products according to embodiments of the invention. It is understood that a block of the block diagrams and/or flowchart illustrations, and combinations of blocks in the block diagrams and/or flowchart illustrations, can be implemented by computer program instructions. These computer program instructions may be provided to a processor of a general purpose computer, special purpose computer, and/or other programmable data processing apparatus to produce a machine, such that the instructions, which execute via the processor of the computer and/or other programmable data processing apparatus, create means for implementing the functions/acts specified in the block diagrams and/or flowchart block or blocks.

These computer program instructions may also be stored in a computer-readable memory that can direct a computer or other programmable data processing apparatus to function in a particular manner, such that the instructions stored in the computer-readable memory produce an article of manufacture including instructions which implement the function/act specified in the block diagrams and/or flowchart block or blocks.

The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions/acts specified in the block diagrams and/or flowchart block or blocks.

As will be appreciated by one of skill in the art, the present invention may be embodied as a method, data processing system and/or computer program product. Thus, the present invention may take the form of an entirely hardware embodiment, an entirely software embodiment or an embodiment combining software and hardware aspects, which may be collectively referred to herein as a “circuit” or “module”.

It should also be noted that in some alternate implementations, the functions/acts noted in the blocks may occur out of the order noted in the flowcharts. For example, two blocks shown in succession may in fact be executed substantially concurrently or the blocks may sometimes be executed in the reverse order, depending upon the functionality/acts involved.

One drawback associated with product placement is that it may be difficult for the advertiser to obtain feedback, and in particular real-time or near real-time feedback, on the effectiveness of the product placement. There may be a fine line between a product placement that is too overt and one that is too subtle, either of which may result in an unfavorable or undesirable reaction from the consumer. Accordingly, it would be desirable for advertisers to be able to obtain real-time or near real-time feedback on the effectiveness of product placement advertising campaigns.

Some methods and systems according to embodiments of the invention may enable an advertiser to obtain interactive feedback from a third-party consumer of an audiovisual program based on product placement markers embedded in the audiovisual program. Product placement markers, also referred to herein as consumer recognition markers, may take a number of different forms. For example, a consumer recognition marker may comprise a product placement in an audiovisual program, such as, for example, when an actor in a movie uses the product in question. Other consumer recognition markers may include, for example, a “mention” of a product in an audiovisual program, such as, for example, when an actor in a program mentions a product by name. An embedded advertisement, such as when a car drives past a billboard for a product in an audiovisual program, may also constitute a consumer recognition marker. In general, a consumer recognition marker may be any word, sound, image or other device which may associate a product or service in the mind of the consumer of the audiovisual program.

As used herein, “audiovisual program” or “A/V program” means any presentation involving images and/or sound including, for example, movies, television shows, streamed video presentations, video games, and the like. Audiovisual content or programs may be broadcast to the general public for reception on a television set and/or broadcast over private networks such as cable and/or satellite networks, cellular communication networks, the Internet, and/or any other suitable network for providing audiovisual programs to a consumer and/or purchased by the consumer at retail (e.g. pre-recorded videos, DVDs, video games, etc.).

Methods of obtaining interactive feedback from third party consumers may include embedding at least one consumer recognition marker in an audiovisual program, and providing the audiovisual program to a third-party consumer. After viewing the audiovisual program, the third-party consumer transmits a message to a response server indicating that the third-party consumer has recognized at least one consumer recognition marker in the audiovisual program. The message may identify the marker and also the consumer. The message may additionally include feedback data indicating, for example, whether the consumer responded favorably or unfavorably to the placement of the consumer recognition marker.

The response server, which may or may not be controlled by the media provider, compares the message from the third-party consumer with the consumer recognition marker to determine if the embedded consumer recognition marker was correctly recognized and interpreted. In addition, the response server may provide a response to the third-party consumer indicating, for example a “score” for the consumer based on the accuracy of the consumer's response.

In some embodiments of the invention, in order to encourage consumers to provide product placement responses, the responding consumer may be entered into a contest, sweepstakes, or other game based on a metric or score assigned to the consumer's response. In some embodiments of the invention, a consumer whose response earns a high enough score may be given an immediate reward, such as a song download, a game download, access to a protected website, and/or some other reward.

The consumer response may be provided through the same communication medium as the audiovisual program was provided. For example, a television program distributed through a cable distribution network may include a consumer recognition marker. The television program may be distributed to households having an interactive set-top box for receiving television signals and displaying the television signals on an associated television monitor. The consumer response may be provided back to the response server through the set-top box communicating through the cable television network. However, in other embodiments, the response may be provided through a different communications system than the audiovisual program was provided through. For example, the response may be provided through a text message over a cellular telephone system, through a website or internet e-mail, interactive voice response, telephone response, and/or other communication medium.

In order to provide feedback and/or a reward to the participating consumer, it may be desirable for the consumer to identify himself or herself to the response server in connection with the response message provided to the response server. Such information may be valuable to the advertiser in assessing the effectiveness of the associated advertising campaign. For example, such information may assist the advertiser in determining whether or not the product placement campaign was effective in raising the awareness of the advertiser's products among a targeted demographic segment.

In some embodiments of the invention, an audiovisual program may include multiple consumer recognition markers embedded at various points of the audiovisual program. A consumer may be asked to identify as many consumer recognition markers as possible. For example, the consumer may be asked to identify the number of consumer recognition markers in a program, the products associated with such consumer recognition markers, the plot points and/or scenes of the audiovisual program associated with the consumer recognition markers, and/or other information which may be used to verify the effectiveness of the placement of the consumer recognition marker in the audiovisual program.

Points may be awarded to the consumer for correctly identifying the number of consumer recognition markers in an audiovisual program, the products associated with such consumer recognition markers, or other facts associated with the consumer recognition markers in the audiovisual program to generate a metric which may be used to gauge the effectiveness of the placement of consumer recognition markers. A reward provided to the consumer may be based on the metric. For example, a consumer may be awarded a number of sweepstakes entries based on the number of correctly identified consumer recognition markers. Alternatively, and/or in addition, a consumer may be awarded a number of song and/or game downloads based on the number of correctly identified consumer recognition markers.

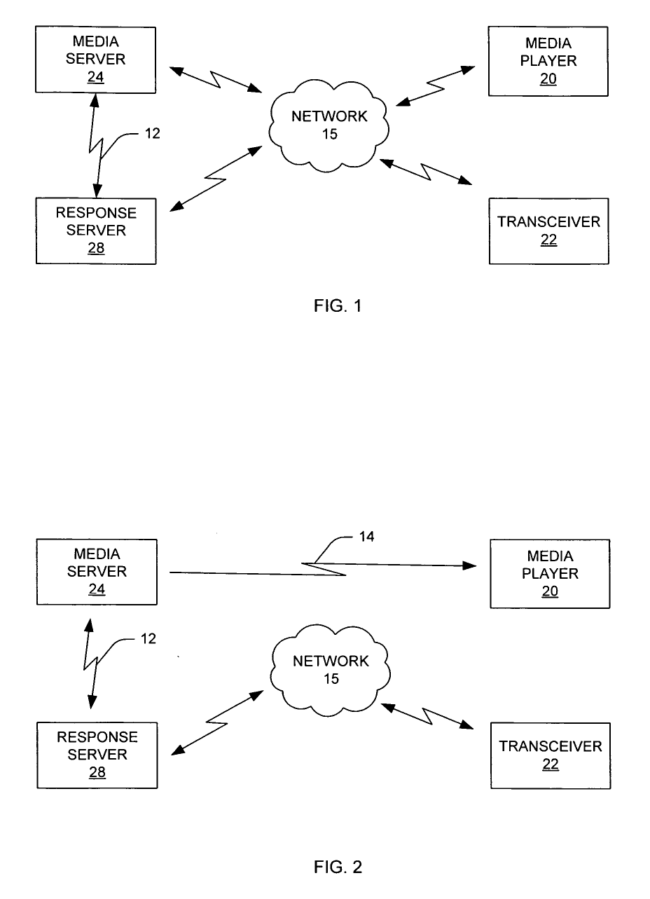

Referring now to the embodiments of FIG. 1, systems for providing interactive advertising programs using product placement are illustrated. In the systems illustrated in FIG. 1, a media server 24 provides an audiovisual program over a communication network 15 to a media player 20 operated by a third-party consumer. The third-party consumer plays the audiovisual program using the media player 20. Responsive to identifying at least one consumer recognition marker in the audiovisual program, the third party consumer uses a transceiver 22 to send a response message back through network 15 to a response server 28 which receives and processes the response from the third-party consumer. In some embodiments, the response server 28 may obtain data from the media server 24 concerning consumer recognition markers embedded in the audiovisual program. For example, the response server 28 may communicate to the media server 24 using a communications link 12 to obtain data from the media server 24 concerning consumer recognition markers embedded in the audiovisual program. The response server 28 may compare such data to a response received from the third-party consumer to determine the metric or score for the consumer's response. The response server 28 may provide a response back to the transceiver 22 via network 15 indicating what reward, if any, the third party consumer has earned as a result of providing the consumer recognition message.

As discussed above, network 15 may include a cable television distribution network, the Internet, a cellular communication network and/or any other communication network capable of supporting transmission of audiovisual programs to end users and the communication of messages from the end users back to a third party. Various protocols for multicasting and broadcasting audiovisual programs over wireless networks have been proposed. For example, MBMS (Mobile Broadcast/Multicast Service) and DVB-H (Digital Video Broadcast—Handheld) protocols have been proposed. DVB-H, in particular, is an extension of a digital video broadcast protocol that has been implemented on wired networks in Europe.

Media player 20 may be any device capable of receiving and playing an audiovisual program, such as, for example, a television set, a videogame controller, a handheld computer or personal digital assistant (PDA), a cellular telephone, or any other device having an appropriate user interface and configured to display an audiovisual program. Likewise, media server 24 may be any system or device configured to transmit, broadcast, and/or multicast, an audiovisual program via a network 15 to a media player 20. Response server 28 may be for example, a programmed digital computer configured to communicate via network 15 with a transceiver 22 and to store data and process responses relative to consumer recognition markers embedded in the audiovisual program. The response server 28 may also be configured to communicate either directly over a communication link 12 or via network 15 or some other series of communication links with the media provider 24.

Referring now to the embodiments of FIG. 2, the audiovisual program may be provided by the media server 24 to the media player 20 via a direct communication link 14 such as, for example, an over-the-air television signal broadcast. That is, the audiovisual program may be provided by a direct link 14 while the consumer response may be provided separately through network 15 to the response server 28.

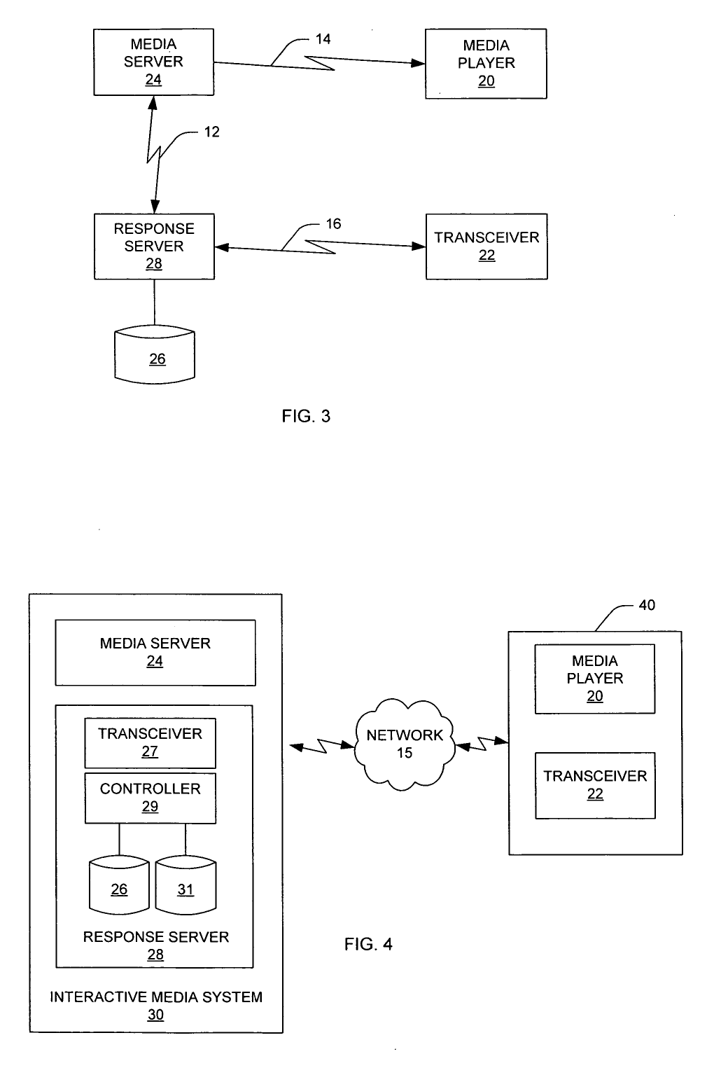

As illustrated in FIG. 3, the response provided by the transceiver 22 to the response server 28 may be provided via a direct communication link 16 such as, for example, a point-to-point wireless transmission.

In the embodiments of FIG. 2, network 15 may be, for example, a public switched telephone network (PSTN), a wireless communication network, the Internet, or any other appropriate communication networks. Network 15 may include both wired and/or wireless communication links and messages flowing through network 15 may be stored and forwarded at one or more intermediate communication nodes.

As further illustrated in FIG. 3, response server 28 may be connected to a consumer information database 26 which stores information concerning consumer recognition markers embedded in audiovisual programs. Consumer information database 26 may also be used to store consumer recognition messages provided by third-party consumers and/or consumer identification information which may be used to correlate information such as, for example, demographic information, with consumer marker recognition responses. Consumer information database 26 may also store other information regarding third party consumers such as, for example, a total number of responses submitted by the consumer, a lifetime or total score earned by the consumer, etc.

As illustrated in FIG. 4, media server 24, response server 28 and consumer information database 26 may be provided within a interactive media system 30. Accordingly interactive media system 30 may perform all of the functions described above with respect to media provider 24, response server 28 and database 26. Interactive media system 30 may communicate through network 15 where a consumer device 40 includes a media player 20 and the transceiver 22.

Response server 28 may further include a transceiver 27 configured to communicate with transceiver 22 over network 15. Response server 28 may further include a controller 29 configured to control the operations of response server 28. Along with the consumer identification database 26, a marker identification database 31 may be connected to controller 29 to enable response server 28 to access information concerning consumer identification markers embedded in audiovisual programs.

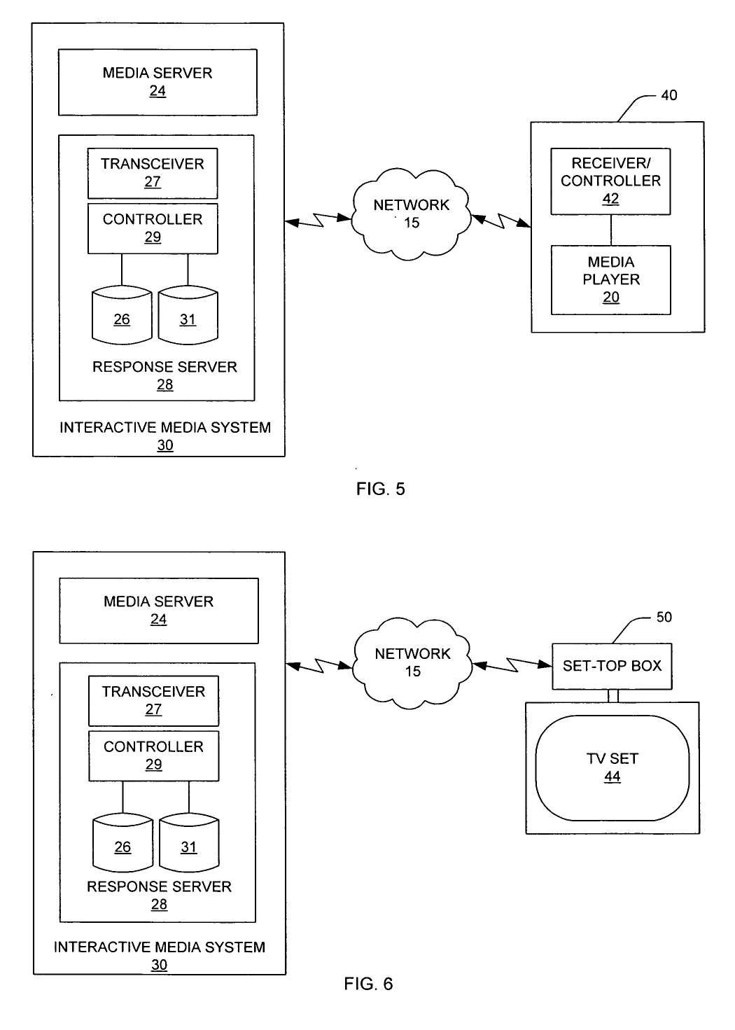

In further embodiments illustrated in FIG. 5, the consumer device 40 may include a receiver/controller 42 which receives the audiovisual program over the network 15 from the media server 24 and provides the audiovisual program to the media player 20 connected thereto.

In further embodiments illustrated in FIG. 6, the Interactive media system 30 communicates over network 15 with a set-top box 50 which receives and processes audiovisual data. The audiovisual data is displayed on an associated TV set 44. Thus, in the embodiments illustrated in FIG. 6, the consumer response may be provided through the set-top box communicating through the cable television network. In other embodiments, while the audiovisual data may be received and displayed on the TV set 44 using the set-top box 50, the response may be provided through a different communications system than the audiovisual program was provided through. For example, the response may be provided through a text message over a cellular telephone system, through a website or internet e-mail, interactive voice response, telephone response, and/or other communication medium.

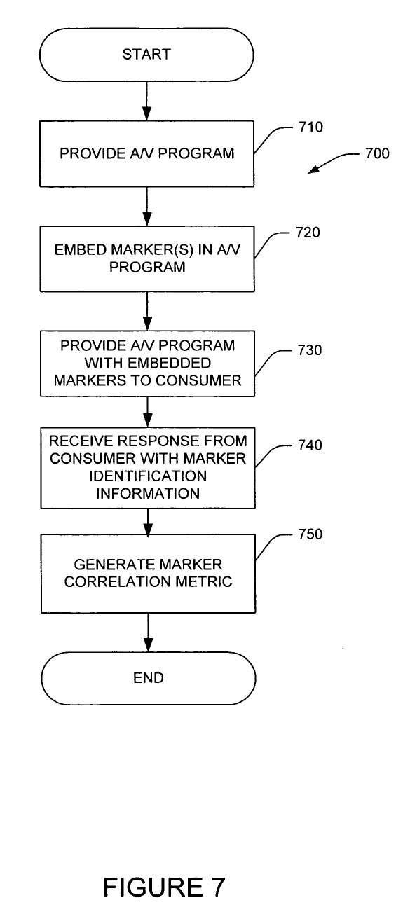

Referring to FIG. 7, methods according to some embodiments of the invention are illustrated in the flow diagram 700. As illustrated therein, an audiovisual (A/V) program is provided (block 710). The A/V program may be a movie, a television show, a streamed video presentation, a video game, and/or any other A/V program. One or more consumer recognition markers are embedded in the A/V program (block 720). In some embodiments, the consumer recognition markers may be embedded in the A/V program during production, for example, during the filming of the movie or television show. In some embodiments of the invention, a consumer recognition marker may be embedded in the A/V program after production. For example, the consumer recognition marker may be inserted into the A/V program by the Interactive media system 30 before the A/V program is transmitted to the consumer.

In some cases, one or more consumer recognition markers may be embedded into an A/V program by digitally overwriting existing props and/or images in the A/V program with a consumer recognition marker. For example, a billboard in the A/V production may be digitally overwritten with a billboard advertisement for the product being placed. As another example, a product, such as a soda can, used in the A/V production may be digitally altered to bear the logo and/or image of the subject product.

In some cases, the A/V program provided to the Interactive media system 30 may have one or more pre-made “place-holders” into which a consumer recognition marker may be placed. For example, an image of a billboard in an A/V program provided to the Interactive media system 30 may blank or may be entirely covered with a chroma key color that may be easily replaced with a desired image. Chroma key techniques are well known techniques for inserting one image or video stream into another.

In some embodiments of the invention, a consumer recognition marker may be inserted into the A/V program even though there is no “place-holder” or existing feature or image to be overwritten, for example by inserting an image of a product into a scene of an A/V production. As an example, a soda can may be digitally inserted into a scene of an A/V program to appear as though it is sitting on a table that is actually in the scene.

The insertion of consumer recognition markers into an A/V production may be performed by the content producer when the program is created, by the Interactive media system 30 before the A/V program is transmitted to the consumer, and/or by a third party processor that receives the A/V program from the content producer and provides a modified A/V program having the embedded consumer recognition markers therein to the media provider 24. In any case, when the consumer recognition markers are embedded into the A/V program, a record of the markers is generated and is provided to the response server 26 which uses the record of the markers to determine the accuracy of an identification response received from a consumer. The record of consumer recognition markers contained in a particular A/V program may be stored by the response server in the database 26.

Continuing with the description of FIG. 7, the A/V program with embedded consumer recognition markers is provided to a consumer (block 730). As discussed above, the A/V program may be provided to the consumer via a broadcast signal, a multicast signal or a point-to-point signal. The program may be provided over a public network and/or a private network such as a cable network, cellular network, etc. In some embodiments, a message may optionally be sent to the consumer inviting the consumer to submit a response. For example, an email or text message may be sent to the consumer inviting the consumer to submit a response. In some embodiments, a message indicating that the consumer may submit a response may be added to the A/V program, such as in information bar on the screen, an icon, or some other communication means.

A response is received from the consumer (block 740). The response from the consumer contains marker identification information. For example, the marker identification information may include the number of consumer recognition markers in a program, the products associated with such consumer recognition markers, the plot points and/or scenes of the A/V program associated with the consumer recognition markers, and/or other information which may be used to verify the effectiveness of the placement of the consumer recognition marker in the audiovisual program.

The marker identification information provided by the consumer is used to generate a marker correlation metric (block 750), which may indicate a “score” of the consumer's response. In particular, the response server 28 may retrieve information from the marker identification database 31 and compare it with the marker identification information provided by the consumer. The marker correlation metric may provide a metric of the effectiveness of the placement of the consumer recognition marker in the audiovisual program. That is, a higher metric may indicate that the consumer correctly recognized and identified a larger number of consumer identification markers embedded in the A/V program.

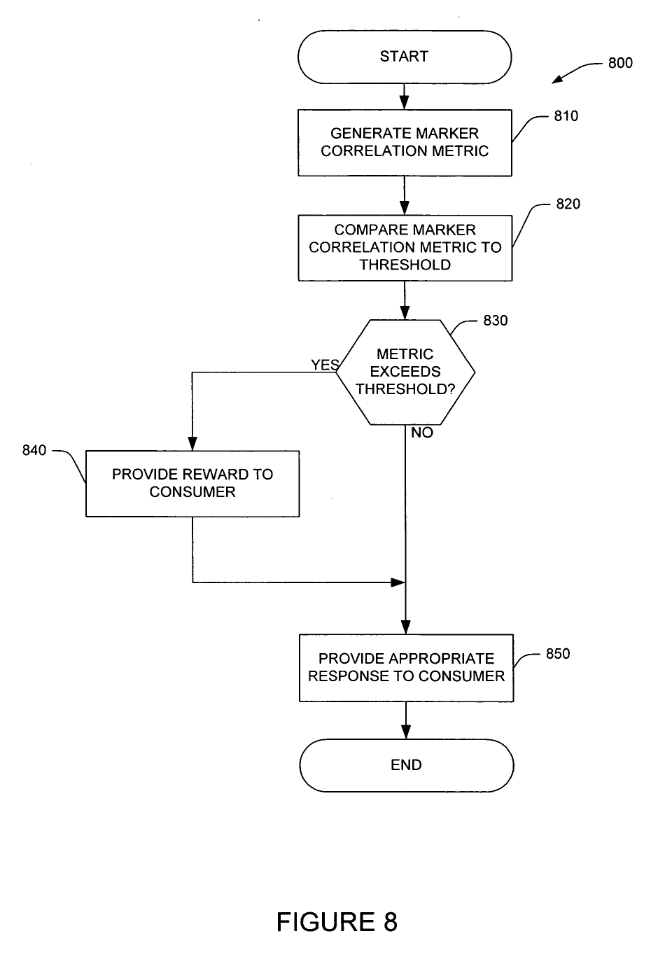

The marker correlation metric may be used to determine an appropriate response and/or reward that may be provided to the consumer respondent. Referring to the embodiments of FIG. 8, flow diagram 800 illustrates some possible steps that may be taken in response to the generation of a marker correlation metric. For example, after a response is received from a consumer respondent, a marker correlation metric is generated (block 810). The marker correlation metric may be generated, for example, by counting the number of correctly identified consumer recognition markers in the response. Alternatively, points may be assigned for particular consumer recognition markers, and the metric may be calculated by adding points associated with correctly identified consumer recognition markers.

After it has been calculated, the marker correlation metric is compared to a predetermined threshold (blocks 820, 830). If the marker correlation metric exceeds the predetermined threshold, an appropriate reward is provided to the respondent (block 840). If not, an appropriate response is provided to the consumer (block 850). It will be understood that methods according to the invention may provide multiple thresholds and multiple rewards. For example, responses that exceed a low threshold may earn a first reward, while responses that exceed a larger threshold may earn a greater reward.

As discussed above, rewards that may be provided to respondents based on their respective marker correlation metrics may include entry into a contest, sweepstakes, or other game, a song download, a game download, access to a protected website, and/or some other reward.

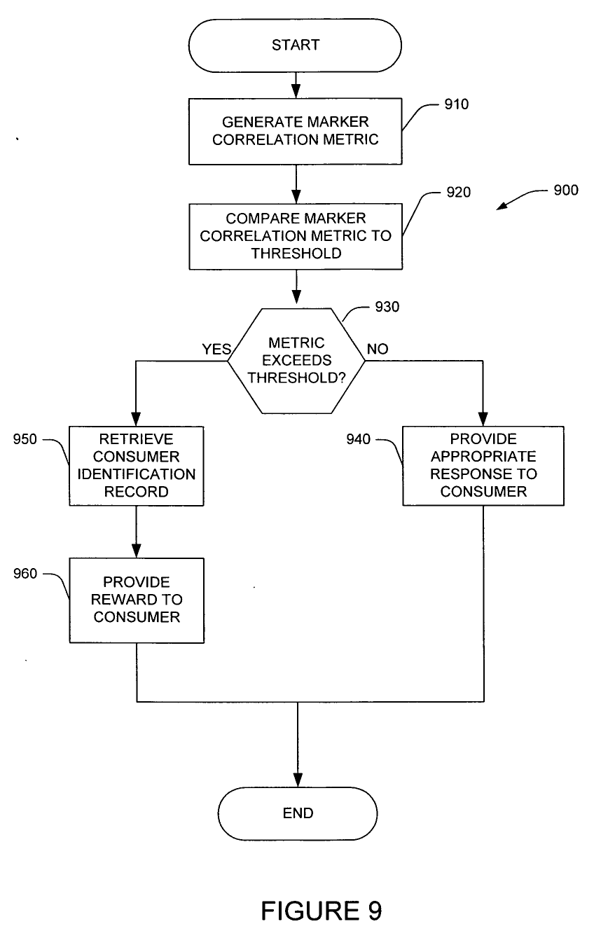

Further embodiments of the invention are illustrated in the flow diagram 900 of FIG. 9. As illustrated therein, after a response is received from a consumer respondent, a marker correlation metric is generated (block 910). The marker correlation metric is then compared to a predetermined threshold (blocks 920, 930). If the marker correlation metric does not exceed a predetermined threshold, an appropriate response is provided to the respondent (block 940). However, if the marker correlation metric exceeds the predetermined threshold, a consumer identification record is retrieved (block 950) and an appropriate reward is provided to the consumer (block 960). The consumer identification record may be stored, for example, by the response server 28 in database 26. Thus, according to some embodiments of the invention, contact information for consumer respondents may be obtained and stored separately from providing the A/V program to the consumer. For example, a consumer respondent could sign up to participate in product placement promotions and provide his or her contact information to the advertiser. The contact information may be stored in the response server 28. Thus, each time the consumer provides a marker identification response to the response server 28, the consumer may not provide full contact information, but may only provide an identification code, such as a password, an email address or the like.

In the drawings and specification, there have been disclosed typical embodiments of the invention and, although specific terms are employed, they are used in a generic and descriptive sense only and not for purposes of limitation, the scope of the invention being set forth in the following claims.

1. A method of obtaining interactive feedback from a third party consumer of audiovisual content, comprising:
receiving a response from the third party consumer, the response identifying one or more embedded consumer recognition markers in an audiovisual program provided to the third party consumer;
generating a marker correlation metric based on the response;
comparing the marker correlation metric to a threshold.

2. The method of claim 1, further comprising:
providing a response to the third party consumer in response to the marker correlation metric exceeding the threshold.

3. The method of claim 1, further comprising sending a message requesting the response to the third party consumer.

4. The method of claim 1, further comprising:
providing the response to a response server, the response server including a database; and
retrieving a record from the database corresponding to the audiovisual program.

5. The method of claim 4, wherein the response server further comprises a consumer identification database and wherein the response further identifies the third party consumer, the method further comprising retrieving a consumer identification record associated with the identified consumer in response to the marker correlation metric exceeding the threshold.

6. The method of claim 5, wherein the identification of the third party consumer in the response comprises a consumer identification code.

7. The method of claim 6, further comprising selecting a consumer identification record for retrieval based on the consumer identification code.

8. The method of claim 1, further comprising providing the audiovisual program to the third party consumer by providing the audiovisual program to an audiovisual display device.

9. The method of claim 8, wherein providing the audiovisual program to the third party consumer comprises transmitting the audiovisual program to the third party consumer over a communication network.

10. The method of claim 9, wherein receiving a response from the third party consumer comprises receiving a response over the communication network.

11. The method of claim 9, wherein receiving a response from the third party consumer comprises receiving a response using an interactive voice response system.

12. The method of claim 1, further comprising embedding at least one consumer recognition marker in the audiovisual program.

13. The method of claim 12, wherein embedding at least one consumer recognition marker is performed after production of the audiovisual program.

14. The method of claim 1, further comprising providing a reward to the third party consumer in response to the marker correlation metric exceeding the threshold.

15. The method of claim 14, wherein the reward comprises an entry into a sweepstakes, a song download, a game download, and/or access to a protected website.

16. The method of claim 15, wherein the reward comprises an entry into a sweepstakes and wherein the number of sweepstakes entries awarded to the third party consumer is based on the marker correlation metric.

17. A system for obtaining interactive feedback from a third party consumer of audiovisual content, comprising:
a response server configured to: (a) receive a response from a third party consumer, the response comprising at least a marker identification message identifying one or more embedded consumer recognition markers in an audiovisual program, and (b) generate a marker correlation metric based on the marker identification message.

18. The system of claim 17, wherein the response server is configured to compare the marker correlation metric to a threshold, and to provide a response to the third party consumer in response to the marker correlation metric exceeding the threshold.

19-22. (canceled)

23. A computer program product for obtaining interactive feedback from a third party consumer of audiovisual content comprising a computer readable medium having computer readable program code embodied therein, the computer readable program product comprising:
computer readable program code configured to (a) receive a response from the third party consumer, the response identifying one or more embedded consumer recognition markers in an audiovisual program provided to the third party consumer, and (b) generate a marker correlation metric based on the response.

24. The computer program product of claim 23, wherein the computer readable program code is configured to compare the marker correlation metric to a threshold, and to provide a response to the third party consumer in response to the marker correlation metric exceeding the threshold.

25-28. (canceled)
